(19) United States
(12) Patent Application Publication
(10) Pub. No.: US 2006/0082360 A1
(43) Pub. Date: Apr. 20, 2006

(54) Apparatus and method for use with a seat of a vehicle

(75) Inventors: David L. Becker, White Lake, MI (US); Aaron Mills, Dexter, MI (US); Michael Fullerton, Ypsilanti, MI (US); Timothy M. Hannon, Commerce Township, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 10/964,073

(22) Filed: Oct. 13, 2004

(51) Int. Cl. G01B 7/30; G08B 21/00

(52) U.S. Cl. 324/207.2; 340/667

(57) ABSTRACT

A vehicle seat occupancy detector 30 provides an output indicative of whether or not the vehicle seat 12 is occupied. The seat occupancy detector 30 includes a Hall effect device 82 which is exposed to a magnetic field provided by a magnet 80.

### BACKGROUND OF THE INVENTION

The present invention relates to an improved seat occupancy detector which provides an output indicative of whether or not a vehicle seat is occupied.

The deployment of an air bag in the event of a crash may be controlled as a function of the presence of an occupant in a seat in a vehicle. When the vehicle seat is unoccupied, it may be desirable to have the air bag remain in an undeployed condition.

### SUMMARY OF THE INVENTION

The present invention provides an apparatus and method for use in association with a seat of a vehicle. The apparatus includes an improved seat occupancy detector which provides an output indicative of whether or not the vehicle seat is occupied.

The improved seat occupancy detector may include a magnet and a Hall effect device which are disposed adjacent to the seat of the vehicle. The Hall effect device is exposed to a magnetic field which is provided by the magnet. The magnetic field to which the Hall effect device is exposed changes when occupancy of the seat changes between an unoccupied condition and an occupied condition. The change in the magnetic field results in a change in the output from the Hall effect device. This change in output from the Hall effect device may be utilized by a control apparatus to determine whether or not vehicle seat is unoccupied.

In one specific embodiment of the invention, the magnetic field provided by the magnet in the seat occupancy detector changed in response to a change in distance between a first member connected with a spring of the vehicle seat and a second member connected with a frame of the vehicle seat. A compensator assembly was provided to move the first member relative to the seat spring as the seat spring sagged to thereby tend to maintain the distance between the first and second members constant when the seat is in the unoccupied condition even though the seat spring sags.

The present invention includes a plurality of features. These features may be used together in the manner disclosed herein. Alternatively, the features may be utilized separately and/or in combination with various features from the prior art. For example, it is contemplated that the seat occupancy detector may be utilized in association with many different types of devices in a vehicle to facilitate controlling the devices as a function of occupancy of a seat.

### BRIEF DESCRIPTION OF THE DRAWINGS

The foregoing and other features of the invention will become more apparent upon a consideration of the following description taken in connection with the accompanying drawings wherein:

FIG. 1 is a schematic illustration depicting the relationship between a vehicle seat and an occupant of the vehicle seat;

FIG. 2 is a partially exploded view of the vehicle seat of FIG. 1 and illustrating a weight sensor which is used in combination with the vehicle seat;

FIG. 3 is an enlarged fragmentary schematic illustration depicting the relationship between a seat occupancy detector and the vehicle seat of FIG. 2, the vehicle seat being illustrated in an unoccupied condition;

FIG. 4 is a schematic illustration, generally similar to FIG. 3, depicting the vehicle seat in an occupied condition; and

FIG. 5 is a schematic pictorial illustration, generally similar to FIG. 3, illustrating an alternative mounting arrangement for the seat occupancy detector.

### DESCRIPTION OF SPECIFIC PREFERRED EMBODIMENTS OF THE INVENTION

General Description

A vehicle 10 (FIG. 1) has a seat 12 which is occupied by an occupant 14 of the vehicle. A known occupant protection device 18 is provided in the vehicle. Although the occupant protection device 18 may be any one of many known devices, in the specific embodiment illustrated in FIG. 1, the occupant protection device 18 is an air bag. A controller 20 is provided to control inflation of the air bag. One or more sensors 22 are connected with the controller 20 to provide an indication of a crash in which the controller is to activate the occupant protection device 18.

In the embodiment of the invention illustrated in FIG. 1, a weight sensor 26 is connected with the controller 20. The weight sensor 26 has a known construction and provides an output which is a function of the weight of the occupant 14 of the vehicle 10. The output from the weight sensor 26 enables the controller 20 to control activation of the occupant protection device 18 as a function of the weight of the occupant 14.

An improved seat occupancy detector 30 is disposed adjacent to the vehicle seat 12 and provides an output which indicates whether or not the vehicle seat is occupied. The seat occupancy detector 30 is connected with the controller 20. The output from the seat occupancy sensor 30 enables the controller 20 to determine whether or not the vehicle seat 12 is occupied.

When the output from the seat occupancy detector 30 indicates that the vehicle seat 12 is unoccupied, the controller 20 equates the output from the weight sensor 26 to zero. Rezeroing of the weight sensor 26 by the controller 20, when the seat occupancy sensor 30 indicates that the vehicle seat is unoccupied, enables the controller 20 to subsequently determine the weight of an occupant 14 of the vehicle seat.

It is contemplated that the improved seat occupancy detector 30 may be used with or without the known weight sensor 26. For example when the weight sensor 26 is not utilized, the seat occupancy detector 30 may be used to enable the controller 20 to activate the occupant protection device 18 only when there is a crash with the vehicle seat 12 occupied.

Vehicle Seat

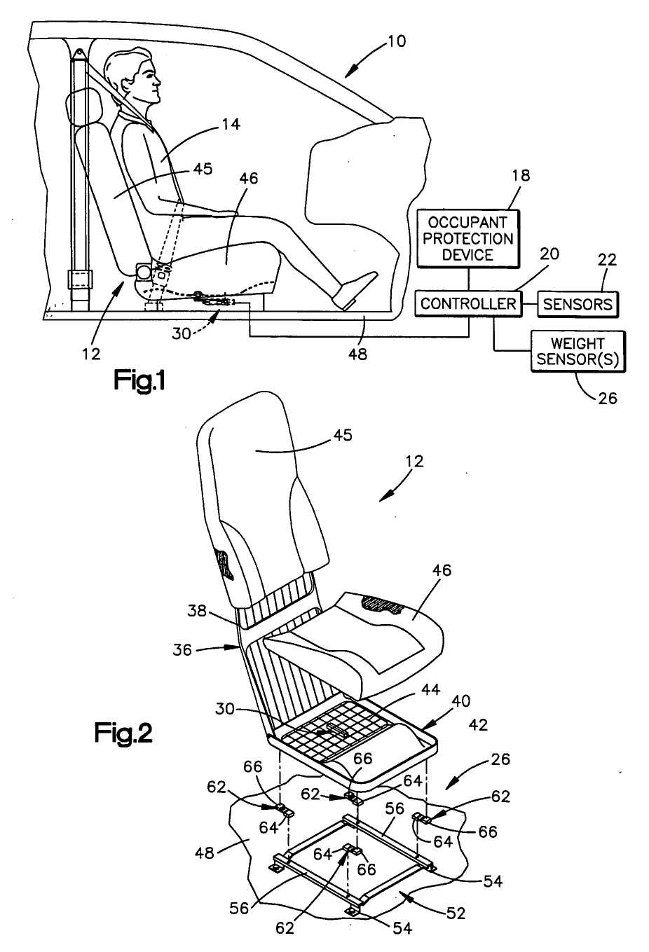

The vehicle seat 12 has a known construction. The vehicle seat 12 includes a metal frame 36 (FIG. 2) having a back portion 38 and a bottom portion 40. The bottom portion 40 of the seat frame 36 includes a metal seat pan 42. Springs 44 are disposed on bottom portion 40 of the seat frame 36. An upper cushion 45 is connected with the back portion 38. A lower cushion 46 is connected with the bottom portion 40.

The bottom portion 40 of the seat frame 36 is connected with a floor 48 of the vehicle 10 (FIGS. 1 and 2). The bottom portion 40 (FIG. 2) of the seat frame 36 is connected with the vehicle floor 48 by a track assembly 52. The track assembly 52 includes lower rails 54 which are fixedly secured to the vehicle floor 48. Upper rails 56 are slidable along the lower rails 54.

Weight Sensor

The weight sensor 26 (FIG. 2) is disposed between the bottom portion 40 of the seat frame 36 and the upper rails 56 of the track assembly 52. When the vehicle seat 12 is occupied, the weight sensor 26 provides an output which is indicative of the weight of the occupant 14 of the seat. When the vehicle seat 12 is unoccupied, the weight sensor 26 provides an output indicative of zero weight.

The weight sensor 26 includes a plurality of seat mounting members 62. The seat mounting members 62 have end portions 64 which are connected to the upper rails 56 of the track assembly 52. The opposite end portions 66 of the seat mounting members 62 are connected to the seat pan 42. The end portions 64 of the seat mounting members 62 extend upward from the upper rails 56. This results in the seat mounting members 62 forming cantilever beams which support the seat 12 on the upper rails 56 of the track assembly 52.

Strain gauges are mounted on the seat mounting members 62 between the end portions 64 and 66 of the seat mounting members. The strain gauges respond to bending of the cantilever beams formed by the seat mounting members 62. The output from the strain gauges indicates the amount of bending of flexible portions of the mounting members 62 disposed between the opposite ends 64 and 66 of the mounting members.

The output from the strain gauges connected with the mounting members 62 is a function of the weight of an occupant of the seat 12. When the seat 12 is unoccupied, the controller 20 equates the output of the strain gauges connected with the seat mounting members 62 to zero. When the seat 12 is occupied, the controller 20 equates the output of the strain gauges to the weight of the occupant of the seat. The weight sensor 26 has the same construction and mode of operation as is disclosed in U.S. Pat. No. 6,039,344.

It should be understood that the weight sensor 26 may have any one of many different known constructions and may be connected with the vehicle seat 12 in any one of many different ways. For example, the weight sensor 26 may be disposed in the lower cushion 46 of the vehicle seat 12. Alternatively, the weight sensor 26 may be disposed between the lower cushion and the bottom portion 40 of the seat frame 36.

Although the illustrated weight sensor 26 utilizes the output from strain gauges to provide an indication which is a function of the weight of an occupant 14 (FIG. 1) of the seat 12, other known types of sensors may be utilized. For example, a fluid pressure sensor may be utilized in association with a bladder containing fluid which is pressurized by the weight of the occupant of the seat 12.

Seat Occupancy Detector

The seat occupancy detector 30 (FIGS. 1, 3 and 4) is constructed in accordance with one of the features of the present invention. The seat occupancy detector 30 has an output which indicates whether or not the vehicle seat 12 is occupied. When the output from the seat occupancy detector 30 indicates that the vehicle seat 12 is unoccupied, the controller 20 (FIG. 1) equates the output of the weight sensor 26 to zero. By rezeroing the weight sensor 26 when the seat occupancy detector senses that the vehicle seat 12 is unoccupied, the output from the weight sensor remains accurately indicative of the weight of an occupant 14 of the seat 12.

The controller 20 is effective to equate the output of the weight sensor 26 to zero each time the seat occupancy detector 30 senses that the vehicle seat 12 is empty. However, it is contemplated that the controller 20 may equate the output of the weight sensor 26 to zero after the condition of the seat 12 has changed between the unoccupied condition and the occupied condition a predetermined number of times. For example, after the seat 12 has been sequentially occupied and unoccupied ten times, the controller 20 may equate the output of the weight sensor 26 to zero.

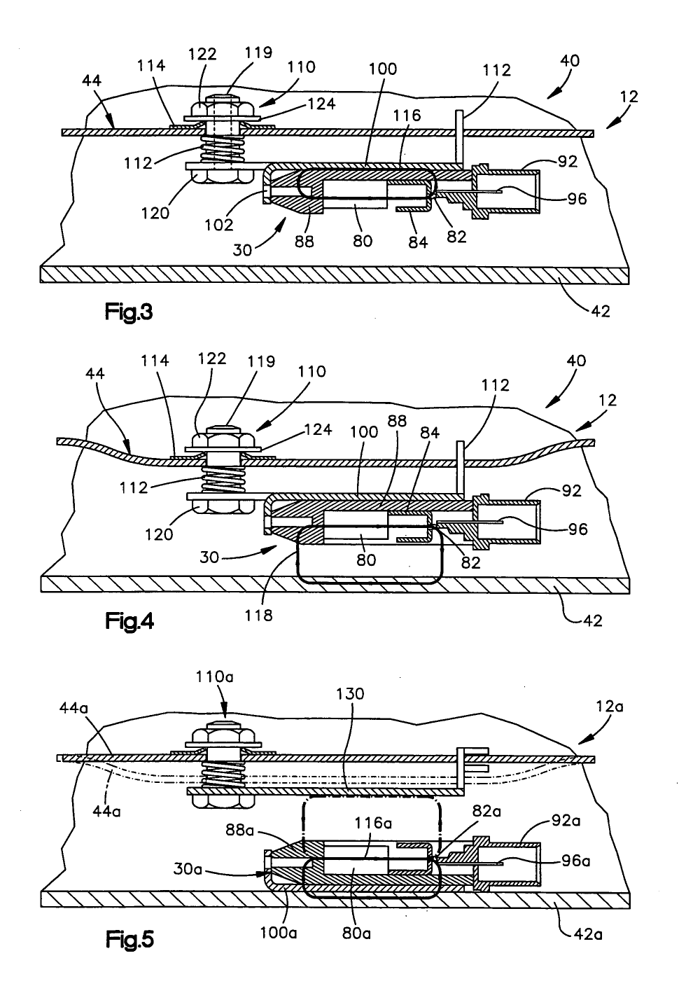

The seat occupancy detector 30 includes a permanent magnet 80 and a Hall effect device 82 (FIG. 3). A member 84, formed of a ferromagnetic material, is provided between the magnet 80 and the Hall effect device 82. The member 84 conducts a portion of the magnetic flux from the magnet 80 to the Hall effect device 82. The magnet 80, Hall effect device 82, and member 84 are partially enclosed by a housing 88 formed of a nonmagnetic material. The illustrated housing 88 is molded as one piece of polymeric material.

A connector 92 (FIG. 3) is connected with the housing 88. Conductors 96 extend through the connector 92. The conductors 96 are connected with the Hall effect device 82 and with the controller 20 (FIG. 1). An output signal is conducted from the Hall effect device 82 to the controller 20 over the conductors 96. The output signal from the Hall effect device is indicative of whether or not the vehicle seat 12 is occupied.

The seat occupancy detector 30 is connected to a metal bracket 100 (FIG. 3) by a screw 102. The bracket 100 is connected with a spring 44 in the bottom portion 40 of the vehicle seat 12 by a compensator assembly 110. A guide 112 extends from the bracket 40 to guide movement of the bracket relative to the spring 44. The spring 44 and seat occupancy detector 30 move relative to the vehicle 10 when the vehicle seat 12 changes between the unoccupied and occupied conditions.

When the vehicle seat 12 is in the unoccupied condition of FIG. 3, the spring 44 and the seat occupancy detector 30 are spaced from the seat pan 42 by a relatively large distance. At this time, a substantial portion of the flux from the magnet 80 is conducted upward from the Hall effect device 82 and through the ferromagnetic material of the bracket 100. There is very little or no downward flow of flux from the Hall effect device 82 to the seat pan 42.

Due to the close proximity of the bracket 100 and the member 84 to the magnet 88, a substantial amount of the magnetic flux from the magnet 80 will be conducted along a magnetic flux path which has been indicated by a relatively heavy line 116 in FIG. 3. At this time, the spacing between the magnet 80 and the ferromagnetic material of the seat pan 42 is such that there is no significant flow of magnetic flux through the seat pan.

When a vehicle occupant 14 is disposed on the seat 12, the spring 44 is deflected downward toward the seat pan 42 and vehicle floor 48 from the unoccupied position of FIG. 3 to the occupied position of FIG. 4. As this occurs, the magnet 80 moves closer to the ferromagnetic material of the seat pan 42. The decrease in the distance between the magnet 80 and the seat pan 42 results in a condition in which a substantial portion of the flux from the magnet 80 flows downward from the Hall effect device 82 through the seat pan, in the manner illustrated schematically by the relatively heavy line 118 in FIG. 4.

When a portion of the magnetic flux shifts from flowing upward through the bracket 100 (FIG. 3) to flowing downward through the seat pan 42, the magnetic field to which the Hall effect device 82 is exposed changes. When the magnet 80 is spaced a substantial distance from the pan 42, in the manner illustrated in FIG. 3 for the unoccupied seat 12, there is a relatively strong upward flowing flux path 116 through the Hall effect device 82. At this time there is no significant downward flow of flux through the seat pan 42.

When the seat 12 is occupied, in the manner indicated in FIG. 4, a substantial flow of flux has shifted and extends downward from the Hall effect device 82 through the seat pan 42. This results in a change in the magnetic field to which the Hall effect device 82 is exposed. The change in the magnetic field to which the Hall effect device 82 is exposed results in a change in the output signal conducted from the Hall effect device to the controller 20.

When the occupant 14 (FIG. 1) moves out of the vehicle seat 12, the vehicle seat changes back from the occupied condition of FIG. 4 to the unoccupied condition of FIG. 3. As this occurs, the magnet 80 and Hall effect device 82 are moved upward (as viewed in FIG. 4) away from the seat pan 42 and vehicle floor 48. The downward flow of magnetic flux from the Hall effect device 82 through the seat pan 42 (FIG. 4) is interrupted. This change in the flow of magnetic flux through the Hall effect device 82 results in a change in the output from the Hall effect device. The change in the output from the Hall effect device 82 indicates to the controller 20 that the vehicle seat 12 is unoccupied. When the controller 20 detects that the vehicle seat 12 is unoccupied, the controller equates the output from the weight sensor 26 to zero to thereby rezero the weight sensor.

The controller 20 detects the change in the output of the Hall effect device 82 with the change in the flow of flux between the condition illustrated in FIG. 3 and the condition illustrated in FIG. 4. This enables the controller 20 to detect the fact that the vehicle seat has changed between the unoccupied condition of FIG. 3 and the occupied condition of FIG. 4.

Compensator Assembly

The compensator assembly 110 compensates for changes in the distance between the spring 44 and the seat pan 42 when the vehicle seat 12 is in the unoccupied condition of FIG. 3. It is contemplated that the spring 44 will sag after the vehicle 10 (FIG. 1) has been used over a period of time. Sagging of the spring 44 tends to reduce the distance between the seat occupancy detector 30 and the seat pan 42. The compensator assembly 110 is effective to change the position of the bracket 100 relative to the spring 44 as the spring sags. This results in the distance between the seat occupancy detector 30 and the seat pan 42 remaining constant when the seat 12 is in an unoccupied condition, even though the spring 44 sags.

The compensator assembly 110 includes a lower (as viewed in FIG. 3) spring 112 and an upper spring 114. The lower spring 112 is a helical coil spring. The upper spring 114 is a washer spring of the bellville type. The lower spring 112 is formed of a material and has a heat treatment condition which is a function of the characteristics of the seat spring 44. The lower spring 112 tends to weaken or sag at the same rate at which the seat spring 44 weakens or sags. The upper spring 114 is formed so as to have a relatively constant strength with the passage of time.

A bolt 119 has a head end portion 120 which engages the bracket 100. A nut 122 on the bolt 118 has a washer 124 which is engaged by the upper spring 114. The lower spring 112 is disposed between the bracket 100 and seat spring 44. This results in the force of the upper spring 114 against the washer 124 being opposed by the force of the lower spring 112 against the seat spring 44.

During use of the vehicle 10, the vehicle seat 12 repeatedly changes between the unoccupied condition of FIG. 3 and the occupied condition of FIG. 4. As this occurs, the seat spring 44 and the helical coil lower spring 112 tend to weaken. The resulting sagging of the seat spring 44 tends to result in the bracket 100 and seat occupancy detector 30 moving downward towards the seat pan 42. However, as the seat spring 44 weakens, the lower spring 112 also weakens. Therefore, the upper spring 114 is effective to move the bracket 100 and seat occupancy detector 30 upward away from the seat pan 42 at the same rate at which the bracket 100 and seat occupancy detector 30 tend to move downward toward the seat pan with sagging of the spring 44. This results in the space between the seat occupancy detector remaining substantially constant with sagging of the seat spring 44.

Seat Occupancy Detector-Alternative Mounting

In the embodiment of the invention illustrated in FIGS. 3 and 4, the seat occupancy detector 30 is connected with the seat spring 44. In the embodiment of the invention illustrated in FIG. 5, the seat occupancy detector is connected with the seat pan. Since the embodiment of the invention illustrated in FIG. 5 is generally similar to the embodiment of the invention illustrated in FIGS. 3 and 4, similar numerals will be utilized to designate the components of the embodiment of the invention illustrated in FIG. 5, the suffix letter “a” being added to the numerals of FIG. 5 to avoid confusion.

In the embodiment of the invention illustrated in FIG. 5, a seat occupancy detector 30a is effective to detect whether or not a vehicle seat 12a is in an occupied condition or an unoccupied condition. In the embodiment of the invention illustrated in FIG. 5, the seat occupancy detector 30a is mounted on the seat pan 42a. To connect the seat occupancy detector 30a with the seat pan 42a, the bracket 100a is fixedly secured to the seat pan 42a. A target plate 130, formed of ferromagnetic material, is connected with a seat spring 44a by a compensator assembly 110a. The target plate 130 moves with the seat spring 44a relative to the seat occupancy detector 30a and the vehicle.

The seat occupancy detector 30a has the same construction as the seat occupancy detector 30 of FIGS. 3 and 4. The compensator assembly 110a has the same construction as the compensator assembly 110 of FIGS. 3 and 4. The seat occupancy detector 30a includes a magnet 80a and a Hall effect device 82a. A housing 88a, formed of a polymeric material, partially encloses the magnet 80a and Hall effect device 82a. The Hall effect device 82a is connected with the controller 20 (FIG. 1) by a connector 92a and conductors 96a.

When the vehicle seat 12a is in the unoccupied condition indicated in solid lines in FIG. 5, the target plate 130 is spaced a relatively large distance from the magnet 80. A flux flow path 116a extends downward from the Hall effect device 82a and through the bracket 100a in the manner indicated schematically by the heavy solid line in FIG. 5. At this time, there is no significant upward flow of flux from the Hall effect device 82a to the target plate 130.

When the vehicle seat 12a is occupied, the seat spring 44a is deflected downward, from the position shown in solid lines in FIG. 5 to the position shown in dashed lines in FIG. 5. As this occurs, the target plate 130 is moved downward closer to the seat occupancy detector 30a. When the target plate 130 is moved downward toward the magnet 80a in the seat occupancy detector 30a, a substantial upward flow of flux is established from the Hall effect device 82a through the target plate 130 in the manner illustrated in dashed lines in FIG. 5. As this occurs, the magnetic field conducted through the Hall effect device changes. This change in the magnetic field being conducted through the Hall effect device 82a results in a change in the output conducted from the Hall effect device through the conductors 96a to the controller 20. The change in the output from the Hall effect device 82a will enable the controller 20 to detect the fact that the vehicle seat 12a is occupied.

In the embodiment of the seat occupancy detector 30 illustrated in FIGS. 3-5, the magnet 80 and Hall effect device 82 are fixedly interconnected by the housing 88. However, it is contemplated that the Hall effect device 82 and magnet 80 may be movable relative to each other. For example, the magnet 80 may be connected with the seat spring 44 and Hall effect device 82 may be connected with the seat pan 42. When the vehicle seat 12 changes from the unoccupied condition to the occupied condition, the magnet 80 will move downward relative to the Hall effect device 82 with a resulting change in the output from the Hall effect device. Of course, the Hall effect device 82 may be connected with the vehicle seat spring 44 and the magnet 80 may be connected with the seat pan 42 if desired.

1. An apparatus for use in association with a seat of a vehicle, said apparatus comprising:
a magnet which is disposed adjacent to the seat of the vehicle;
a Hall effect device which is exposed to a magnetic field which is provided by said magnet, the magnetic field to which said Hall effect device is exposed changes when occupancy of the seat of the vehicle changes between an unoccupied condition and an occupied condition to thereby change an output from said Hall effect device; and
a control apparatus which is connected with said Hall effect device.

2. An apparatus as set forth in claim 1 wherein a portion of the vehicle seat moves relative to a portion of the vehicle when the vehicle seat changes between the unoccupied condition and the occupied condition, said magnet is connected with said portion of the vehicle seat which moves when the vehicle seat changes between the unoccupied condition and the occupied condition.

3. An apparatus as set forth in claim 1 wherein a portion of the vehicle seat moves relative to a portion of the vehicle when the vehicle seat changes between the unoccupied condition and the occupied condition, said Hall effect device is connected with said portion of the vehicle seat which moves when the vehicle seat changes between the unoccupied condition and the occupied condition.

4. An apparatus as set forth in claim 1 wherein a portion of the vehicle seat moves relative to a portion of the vehicle when the vehicle seat changes between the unoccupied condition and the occupied condition, said magnet and said Hall effect device are connected with said portion of the vehicle seat which moves when the vehicle seat changes between the unoccupied condition and the occupied condition.

5. An apparatus as set forth in claim 1 wherein a first portion of the vehicle seat moves relative to a second portion of the vehicle seat when the vehicle seat changes between the unoccupied condition and the occupied condition, said magnet and said Hall effect device are connected with said second portion of the vehicle seat.

6. An apparatus as set forth in claim 1 further including a housing which at least partially encloses said magnet and said Hall effect device and which maintains said magnet and said Hall effect device in a predetermined spatial relationship with each other.

7. An apparatus as set forth in claim 6 wherein said housing is connected with a spring in the vehicle seat and is movable with the spring when the vehicle seat changes between the unoccupied condition and the occupied condition.

8. An apparatus as set forth in claim 6 wherein said housing is connected with a frame of the vehicle seat and remains stationary relative to the frame of the vehicle seat when the vehicle seat changes between the unoccupied condition and the occupied condition.

9. An apparatus as set forth in claim 1 wherein the vehicle seat includes a seat frame and a seat spring which may tend to sag relative to the seat frame, said magnetic field provided by said magnet changes in response to a change in distance between a first member connected with the seat spring and a second member connected with the seat frame, and a compensator assembly to move said first member relative to the seat spring as the seat spring sags to thereby tend to maintain a distance between said first and second members constant when the seat is in the unoccupied condition even though the seat spring sags.

10. An apparatus as set forth in claim 9 wherein said compensator assembly includes a first compensator spring which loses strength at a rate which is a function of a rate of loss of strength by said seat spring and a second compensator spring, said second compensator spring being effective to move said first member relative to said seat spring as said seat spring and first compensator spring lose strength.

11. A method comprising the step of:
changing a magnetic field to which a Hall effect device is exposed when occupancy of a vehicle seat changes between an occupied condition and an unoccupied condition; and
providing an output signal from the Hall effect device indicative of whether or not the vehicle seat is occupied.

12. A method as set forth in claim 11 wherein said step of changing a magnetic field to which a Hall effect device is exposed when occupancy of the vehicle seat changes between an occupied condition and an unoccupied condition includes moving a Hall effect device and a magnet with a first portion of the vehicle seat relative to a second portion of the vehicle seat.

13. A method as set forth in claim 11 wherein said step of changing a magnetic field to which a Hall effect device is exposed when occupancy of a vehicle seat changes between an occupied condition and an unoccupied condition includes moving a portion of the vehicle seat relative to a Hall effect device and a magnet.
